(19) United States
(12) Patent Application Publication
(10) Pub. No.: US 2007/0125848 A1
(43) Pub. Date: Jun. 7, 2007

(54) Automatic scanning system, shoppers scanpass system

(76) Inventor: Mike Moshe Bannetto Piamenta, Brooklyn, NY (US)

Correspondence Address: MRA ASSOCIATES, 1312 44th St Ste 214, Brooklyn, NY, 11219, US

(21) Appl. No.: 10/292,688

(22) Filed: Dec. 1, 2005

(51) Int. Cl. G06K 15/00; G06K 7/10

(52) U.S. Cl. 235/383; 235/462.13

(57) ABSTRACT

The checkout system described herein is to show a system how to eliminate the lines at the regiters, to eliminate the removal of items from shopping cart in order to “ring” them at the checkout counters. As clients lowering their goods into shopping carts, an auto scanner mounted at the top of the cart shall trigger a beam to scan the items which are lower into the cart. Once client completes his shopping he than read the total amount of sale which can be verified at the top of the shopping cart. The cart with all the intended purchased items is wheeled to a checkout areas, in which the total amount is paid either by cash or credit cards.

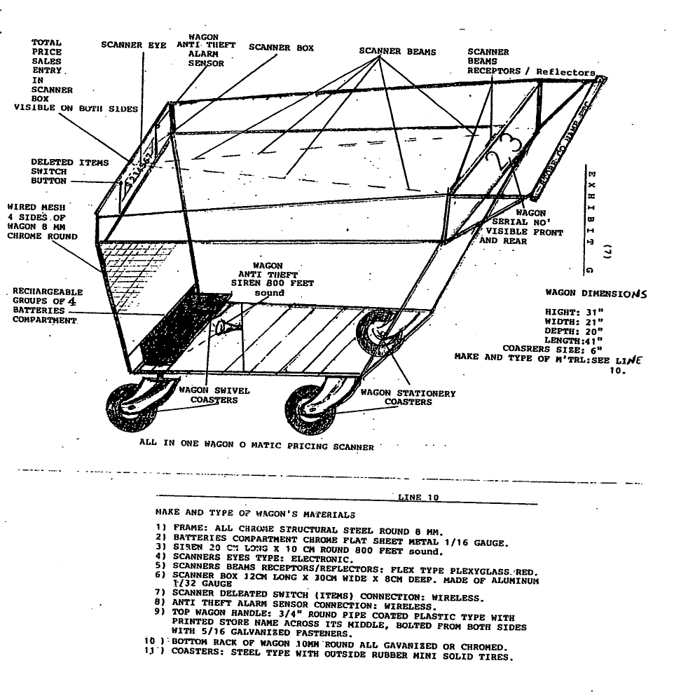

Systematic design for most retail establishments which “ring” their items thru a checkout counter, where clients/shoppers can conduct the process of shopping without the standard waiting on lines in front of cash registers.

### DESCRIPTION

Items meanning any commodity which can be handled mostly by hand, as a self service method of purchase, within retail establishment such as supermarkets, retail chains stores, retail chain outlets of any type of marketing in a self-service system, can benefit greatly by using this system.

Any items which are for the most part are picked up from the selling offering area and are lower into shopping wagons by clients who wheel the wanted goods to the cash registers counters.

Shopping cart.

Specifically designed as carriers and for an automatic instant scanning for all items which are lowered into them. An automatically scanning devise installed at the top brim, frame of shopping cart that electronically sensetive to the coded pricing tags attached to every item. Once an item which carried the coded price tag is passed thru the top frame of the shopping cart and lower onto cart will instantally trigger the pricing scanner installed at their top

Wagons O Matic Pricing Scanner.

Wagons, Carts are made of a type of materials, components and designed specifically to be used as a carriers and scanners. The designed wagons/carts will described in a separate chapter.

Shoppers will have the ability to monitor each item by the unit pricing as well as the price itself thru a scanner window installed at the top of each shopping cart.

In the event of a reversed scanning such as a removal of an item from cart, the scanner installed at the top frame of cart will automatically deduct the amount from the total desired purchase. (By pressing a botton which says CANCEL).

A processing checkout booths shall be constructed at the location designated to receive all carts filled with goods which are wheeled into specifically designed Cashiers scanning booths. Each booth equipped with a remote scanner shall beam directly into the “total price” window located at the top of each shopping cart. A total amount of sale shall be displayed and announced for each individual shopping cart.

Scanning booths shall be equipped with slots machines mounted on their walls to recieve payment for each purchase by cash, credit cards or store cards. Customers shall be instructed to insert cards at appropriate slot machines. Once payments accepted a gate/door will be opened for each shopping cart to be wheeled out into a packing booths or a similar packing counter.

At each gate/door a push button shall activate a trigger for the total sale reciept.

Each time door/gate is opened a cc tv system will monitor that individual shopping cart.

All Check—points of entries and exits shall be monitored by a cc tv systems.

An optional checkout cashier counters, “the old system” will still be operational for those who wish to be informed about various store applications as well as the privilege to converse with cashier in general.

The advantage use of the SCANPASS system is to reduce the long lines in front of each cash registers.

Shoppers will not leave unwanted items by registers.

There will be a dramatic reduction in shoplifting, probably not at all.

If store employees are engaged in theft, than any items not accounted for, unscanned will have to exit the back doors, an area which can be easily monitored at all hours.

Produce and related loose food items shall be packed and wrapped accordingly meaning by wanted desired volume, with a protected see thru wrap, bag which eliminate the direct contact of skin. Each wrapped produced, food bag will carry a scanning tag. and be protected against an outside contact of foreign bacterias, as well as human breath, speach, cough, hair, etc.

No item could be carried out of the store undetected unpaid or unaccounted for, since the scanned tag attached will always trigger the alarm systematic devise on the way out. And if any attempt shall be made to carry the item out of the store thru the SCANPASS exit (gate), then simply the gate will not open.

Type of “labels” attached to all products will be of a design that applicable to the size and shape of the item, and be constructed as a wrap around ribbon with a thin cord inserted or attached to it, visible from all directions for scanning detections and if item relatively large in size than 2 or three scanning labels shall be attached.

Once all shopping carts are moved into the bagging counters which shall be supported by store employees or upon shoppers choice to bag their items themselves, A conveyor belt shall be constructed at that area for all carts to be wheeled on and eventually be carried to the the front store entrance.

SCANPASS System

An Automatic SCANPASS System.

Specifically designed/Systematic design for retail establishments which “ring” their items thru a checkout counter, where clients/shoppers conduct the process of shopping without the standard of waiting on lines in front of the cash registers. and use the specifically special designed built shopping cart/wagon equipped with an automatic scanner at the top of its frame to scan/trigger all items which are entering, lowering into wagons/carts.

SCANPASS To be registered as a trade mark. And said title shall be recognized as a title for the system described herein on page 5 and on exhibit E.

Wagon O Matic System

Wagon O Matic Pricing Scanner.

Specifically designed shopping wagon equipped with an automatic scanner/trigger, mounted at the top of its frame to scan/trigger all item which are lowered into the wagon.

Wagon O Matic

To be registered as a trade mark. and said title shall be recognized as a title for the system described herein on page 6 and on exhibit F.

1. Checkout system eliminating the lines at the register, so to eliminate the removal of items from shopping carts in order to “ring” them at the checkout counters
As clients lowering their goods into shopping carts, an automatic scanner mounted at the top of the carts shall trigger a beam to scan the items which are lowered into the carts.
